(19) United States
(12) Patent Application Publication
(10) Pub. No.: US 2005/0246203 A1
(43) Pub. Date: Nov. 3, 2005

(54) Crucial and significant (C&S) patient information management and display

(76) Inventors: M. S. Laxmi Narayan, Chicago, IL (US); Neema Bhatt, New Berlin, WI (US)

Correspondence Address: NEEMA BHATT, 4915 S. RADISSON CT, NEW BERLIN, WI, 53151, US

(21) Appl. No.: 10/835,417

(22) Filed: Apr. 30, 2004

(51) Int. Cl. G06F 17/60

(52) U.S. Cl. 705/3

(57) ABSTRACT

Method, product and system for Health Care Providers (HCP) to extract, store, organize, password protect, and share crucial and significant (C&S) health, medical, dental, and pharmacy information without regard to healthcare provider systems are provided. All the C&S information contained in a patient's medical record(s) is entered in a customizable screen that can be accessed as soon as a doctor types in the name of the patient or presses a key. Crucial and Significant (C&S) patient information includes but not limited to important history, major diagnoses; major medical procedures and investigations, allergies, drug allergies and blood type. This may also include alerts for important patient directives including but not limited to “do not resuscitate,” “organ donation” etc.

### BACKGROUND OF THE INVENTION

The present invention relates generally to a method and product for managing and displaying information in medical records, and particularly to a method and product for managing crucial and significant (C&S) information in electronic medical records for healthcare providers including primary care physicians. Crucial and significant information may include adverse drug and or food reactions, major and or chronic health conditions, major surgery or medical procedures, genetic information, significant past and family history, personalized reminders and others including information deemed important by a given patient's PCP.

Lack of well-organized and readily available significant health information by healthcare providers continues to be one of the chief causes of patient injury and death. A Harvard Medical School study published in 1999 reported that 50,000 Americans died as a direct result of medical treatment conflict and/or multiple drug interactions. Similarly, multiple studies suggest that between 8% to 15% of Medicare hospital admissions are due directly or indirectly to the lack of patient medical information sharing between providers. Using the conservative estimate of 10%, these unnecessary hospital admissions cost the American taxpayer $40 billion annually not to mention the untold suffering of the patients themselves sometimes leading to death and injury. Millions of dollars are spent annually by the healthcare industry in an attempt to achieve an electronic medical patient record. These efforts have failed largely due to the lack of common technology interfaces between doctors and other providers. Less than 50% of doctors have Internet capability in their practices and less than 20% of healthcare organizations share a common computerized system, which would allow sharing of patient medical data. Legal liability on the part of both patients and providers with respect to privacy also contribute to the problem. Additionally, pharmacy chains have no ability today for their pharmacy management systems to talk to the systems of other dispensing chains and therefore protect patients from drug-drug conflict dangers when multiple prescriptions are filled at pharmacies operated by unrelated organizations.

A need exists for a healthcare practitioner (HCP) electronic medical record capable of collecting, storing, cataloging, displaying and sharing significant health information with authorized medical, dental, and pharmacy providers without dependence upon provider's medical management system platforms, and/or data processing capabilities.

### SUMMARY OF INVENTION

In one embodiment, the invention describes a method to assist a first authorized healthcare practitioner to access crucial and significant information of a patient along with medical data. The method involves recording crucial and significant information as defined by the healthcare practitioner and customizing it with pre defined criteria; It also involves storing crucial and significant information in a computer data storage, accessing the relevant medical data and displaying stored crucial and significant information on a display screen wherein the screen is activated instantly as the patient's identifier is entered by an authorized user for accessing medical data.

In another embodiment the invention describes a system to assist an authorized first healthcare practitioner to access crucial and significant information of a patient along with medical data. The system comprises of a recording means to capture crucial and significant information as defined by the healthcare practitioner in a customizable form; a storage means to store crucial and significant information on a computer; an interface to access medical data; and a display means to display crucial and significant information on a display screen wherein the screen is activated instantly as the patient's identifier is entered by an authorized user for accessing medical data.

In another embodiment the invention describes a computer executable program for assisting an authorized first healthcare practitioner to access crucial and significant information of a patient along with medical data The computer program comprises of at least one machine readable medium; computer code stored on the at least one machine readable medium comprising instructions for recording crucial and significant information as defined by the healthcare practitioner in a customizable form; storing crucial and significant information in a computer data storage; accessing medical data; and displaying stored crucial and significant information on a display screen wherein the screen is activated instantly as the patient's identifier comprising at least one of: patient's name, social security number, or a system assigned unique number is entered by an authorized user for accessing medical data.

### BRIEF DESCRIPTION OF DRAWINGS

FIG. 1: Structure of the C& S Information System

FIG. 2 Exemplary contents of C& S Information System

FIG. 3: Recording system in the C& S Information System

FIG. 4: Accessing System the C& S Information System

FIG. 5: Editing System in the C& S Information System

FIG. 6: Sorting & Saving System in the C& S Information System

FIG. 7: Displaying System in the C& S Information System

FIG. 8: Sharing System within the C& S Information System

FIG. 9: Sharing structure outside the C& S Information System

FIG. 10: Software system within the C& S Information System

FIG. 11: Levels of security within the C& S Information System

FIG. 12: Levels of access within the C& S Information System

FIG. 13: Workflow aspects of C&S data usage

### DETAILED DESCRIPTION

The present invention is directed toward a method of collecting, accessing aggregating, editing, recording, displaying and sharing and saving crucial and significant (C&S) as defined by a patient's primary care provider (PCP). PCP is also some times referred to as the custodial HCP for the purposes of description in the specification. Crucial and significant information may include adverse drug and or food reactions, major and or chronic health conditions, major surgery or medical procedures, genetic information, significant past and family history, personalized reminders and others including information deemed important by a given patient's PCP.

The PCP controls the data, directs inputting of the C&S data. An authorized agent may be used for inputting the C&S data to a database. The PCP sets the levels of access for sharing with other healthcare providers (HCPs) or healthcare agencies. As an example, if mental health information of a patient is deemed not pertinent to share with another HCP, the invention provides the patient's PCP to share only chronic health conditions but not mental health conditions.

The invention is directed toward enabling PCP's to collect, record, manage, and share significant health information pertaining to medical including lab and imaging, dental, and pharmacy information with doctors, dentists, pharmacists, and other health providers they authorize, independent of provider data processing systems.

In another embodiment, the invention is directed towards including all significant health information pertaining to medical, dental, and pharmacy areas to view, edit, update, and print those data elements authorized by the patient or the custodial healthcare provider who is referred here as PCP.

In another embodiment, the invention contains all software necessary for one authorized provider to manually or automatically synchronize identified and predetermined significant health information data subsets with the same patient information data subsets maintained in another provider's office.

In another embodiment, the invention provides the custodial HCP complete control of all data through a master personal identification number (PIN) and password protection of individual data subsets.

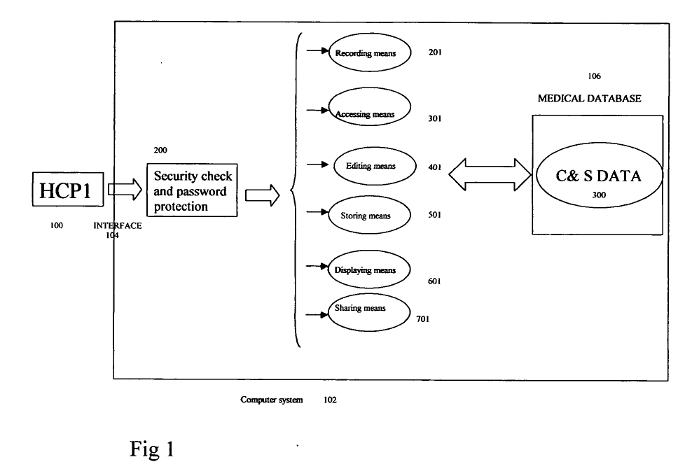

Referring to the FIG. 1, it is shown that the C& S database 300 is an integral part of the overall medical database 106. This database is seamlessly accessed by the PCP 100 after interfacing through the system by an interface means 106. The C& S database is instantly activated when the PCP enters the patient's unique one or more identifiers and a password through the security check and password protection means 200. The PCP 100 is in charge of the entire management of the C&S part of the medical database system. The PCP also has the authority to customize the C& S system using the recording means 201, accessing means 301, editing means 401, temporary storing means 501, display means 601 and sharing means 701.

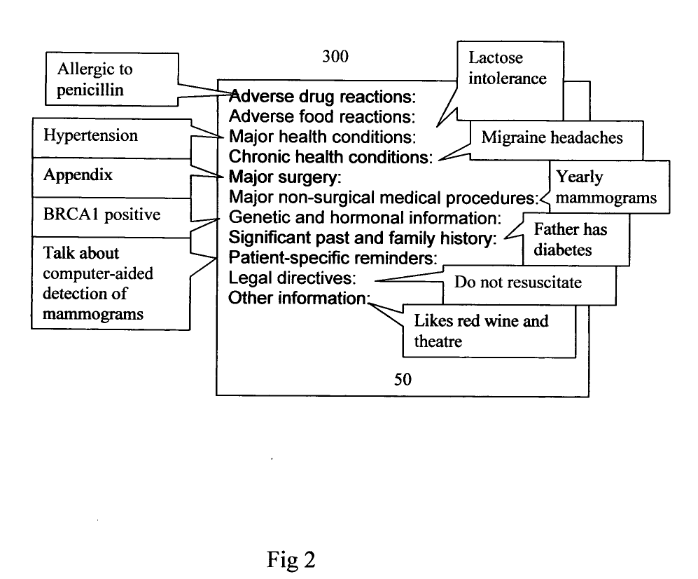

Referring to FIG. 2, exemplary C&S information 300 is shown in detail. The C&S information is presented to the user via an automatically instantiated computer display window 50. As the user moves a cursor through the linked list of C&S information, details of C&S information specific to the patient is displayed. The pop-up information for each item is shown in the callouts. Even though for the purposes of illustration, pop-ups of all items are shown in the FIG. 2, one who knows the art appreciates that one pop-up at a time is shown in practice since the cursor position is on one item at a time.

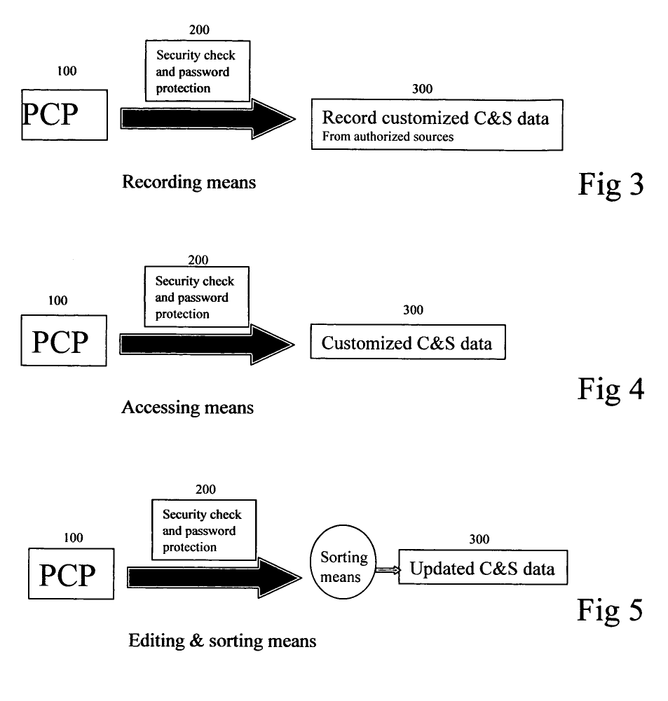

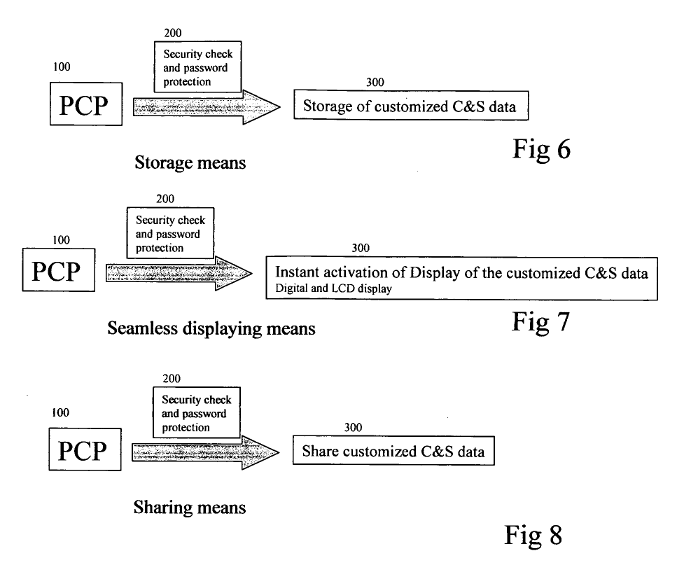

Referring back to FIG. 1, the recording means to customize C& S data (201) can be via manual or automatic input. Manual input can be keyboard entry of data in a predetermined customized format or it can be automatic. Methods for automatic input include, voice recognition software, optical character recognition or any other digital means. The system is elaborated in FIG. 3, wherein the PCP controls the input via password protection and then a system exists to record the customized data from authorized sources.

Referring back to FIG. 1, the access means to customize C& S data (301) can be via manual or automatic interface. Manual interfaces can be using a keyboard and terminal to access the data and/or the Internet via remote login. Automatic accessing can be via updated reporting alerts whenever there is an update to the information contained in the C& S system. As an example of automated access to C&S system would be when the prescription for a life-sustaining drug needs to be refilled or reviewed. The system is elaborated in FIG. 4, wherein the PCP controls the input via password protection (200) and then an appropriate system is used to access the customized data from authorized sources.

Referring back to FIG. 1, the editing means to customize C& S data (401) can be after the necessary security clearance. The editing can take place over the network computers and the saving it will instantly update the C& S records. The editing means may include a text processor, image editor or a video editor. The system is elaborated in FIG. 5, wherein the PCP controls the input via password protection (200) and the customized C& S data is sorted in the system using necessary hardware and software capable of sorting the data and also updated using a keyboard, an image editor or a video editor.

Referring back to FIG. 1, the storage means to customize C& S data (501) can be a computer data storage system consisting of necessary hardware and sufficient memory and can be recalled when the necessary security clearance is obtained. The system is elaborated in FIG. 4, wherein the PCP controls the input via password protection (200) and then an appropriate computer system is used to store the customized data from authorized sources.

Referring back to FIG. 1, the display means to interact with C& S data (601) enables viewing a customized format specified by the main authorized user. The seamless system is further elaborated in FIG. 7. The PCP controls the input via password protection (200) and then an appropriate system is used to display the customized data from authorized sources. The display can be a computer monitor, an independent LCD display and any other digital displays. In each case the display is instantly activated by entering the patient's unique identifier; unless specifically deactivated by the authorized user.

Referring back to FIG. 1, the sharing means for C& S data (701) enables sharing C&S data with other authorized HCP's, hospital system, pharmacies, insurance companies and other stakeholders. The system is elaborated in FIG. 8, wherein the PCP controls the input via password protection (200) and then an appropriate system involving authorized personnel and other communicative devices for electronic sharing of the customized C & S data. The electronic sharing is secure and uses encryption technology to prevent unauthorized interception of this data.

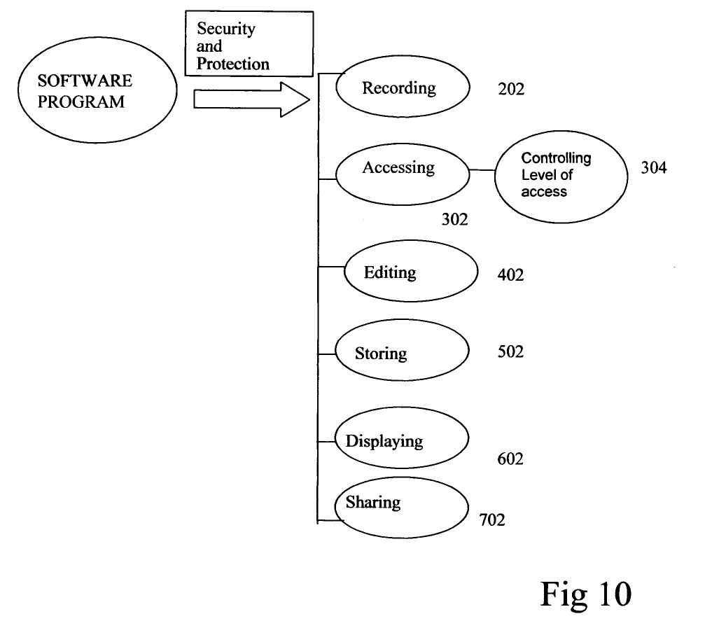

The security in this method and system can be instituted at multiple levels. By means of an example, a three-level security scheme is described in FIG. 10. The first level (204) requires maximum-security clearance when an individual needs to access, read, edit, record and share the information. Typically authorized personnel in charge of the patient's care and records will maintain the C& S data of the patient and retain this level of security clearance. The second level (206) requires medium security clearance and a person can read and edit the information contained in the C& S information. Office administrative personnel responsible for the patient's healthcare needs will have the ability to read and edit the patient's C& S information. The third level (208) requires security clearance to read the information off the display. These are typically other agencies involved in the C&S delivery like pharmacies other HCP's that need to be a part of providing healthcare needs as determined by patient's primary authorized HCP.

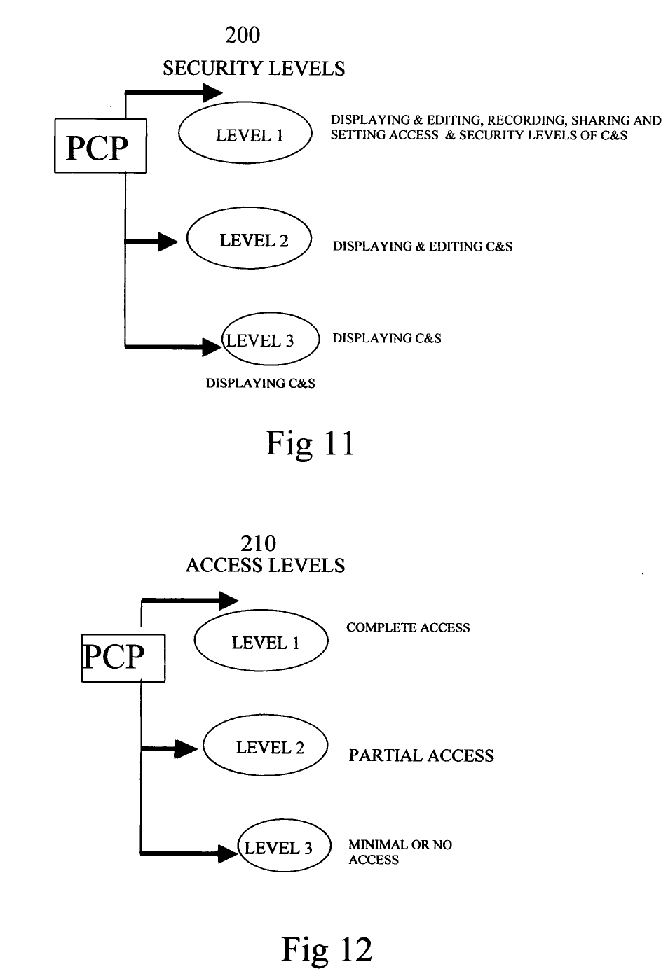

The access control in this method and system can be instituted at multiple levels. By means of an example, a three-level access control scheme 210 is described in FIG. 11. The PCP sets the levels of access for sharing with other healthcare providers (HCPs) or healthcare agencies. The first level of access is usually limited to the PCP 100. The second level of access allows access to specific information contained in the C&S information. Examples of this level of access would be for a second HCP to access C&S information. As an example, if mental health of a patient is deemed not pertinent to share with another HCP, the invention provides the patient's PCP to share only chronic health conditions but not mental health conditions. The third level of access is even more specific. For example, a pharmacist only needs to know about drug allergies and interactions pertaining to a patient.

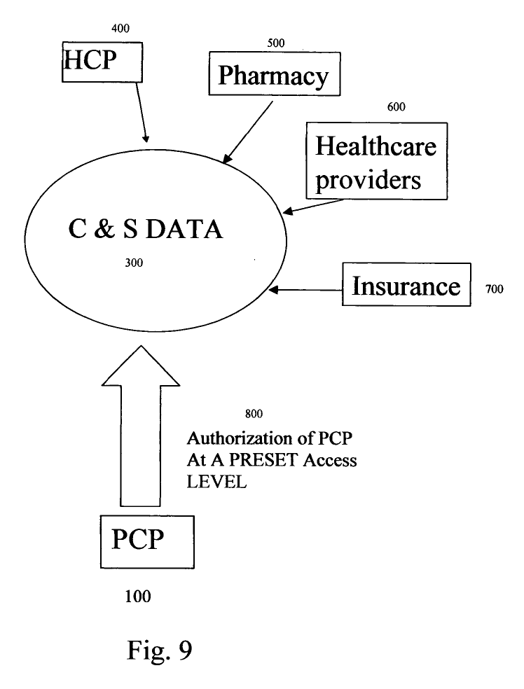

Referring to FIG. 9, the software program that is used in the C& S system will be independent of the platforms used in the different organizations (400, 500, 600, and 700). The software program is also rendered compatible to use on different platforms. The structure consists of code to perform the following functions including recording data, accessing data, editing data, storing data, displaying data and sharing data. It also controls the levels of access and levels of security decided by the primary caretaker of the data, PCP 100.

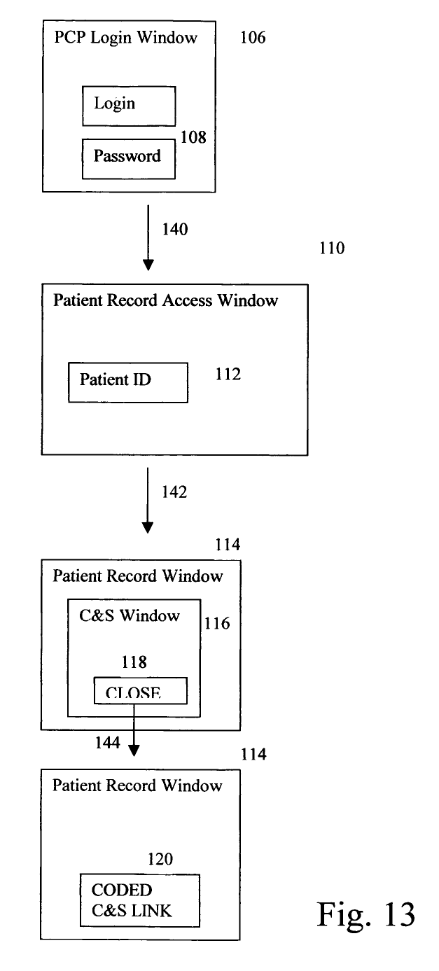

Referring to FIG. 13, the PCP uses PCP login window 106 and enters the login name and password (108). The security check 140 ensures the validity of 108 and allows access the patient record access window 110. The PCP proceeds to access a patient's record by selecting at least one of patient's name, patient's identification number, or a computer-generated code corresponding the patient 112. The software program triggers the instantaneous access to window containing the C&S data 116 at the time a patient's record from the medical database is accessed. Since C&S data is provided in an unobtrusive manner, it is preferably displayed on a popup window that can be closed. The PCP can close the C&S window using for example the close button 118. However, if the PCP wants to access the C&S data at a later time, she can click on the unobtrusive C&S link 120 to access the C&S data. The C&S link can be coded to indicate the presence or absence of C&S data for the patient. The coding can be in the form color, font or various text effects including blinking.

It is to be understood that the phraseology or terminology employed herein is for the purpose of description and not of limitation. Accordingly, the invention is intended to embrace all such aternatives, modifications, equivalents and variations as fall within the spirit and broad scope of the appended claims.

1. A method to assist a first authorized healthcare practitioner to access crucial and significant information of a patient along with medical data, the method comprising:
recording crucial and significant information as defined by the healthcare practitioner in a customizable form;
storing crucial and significant information in a computer data storage;
accessing medical data; and
displaying stored crucial and significant information on a display window wherein the window is activated instantly as the patient's identifier is entered by an authorized user for accessing medical data.

2. The method according to claim 1 further comprising:
editing crucial and significant information and saving the edits.

3. The method according to claim 2 further comprising:
sorting crucial and significant information according to a set of healthcare practitioner defined criteria.

4. The method according to claim 3 wherein crucial and significant information comprises at least one of: adverse drug reactions; adverse food reactions; major health conditions; chronic health conditions; major surgery; major dental and medical procedures; genetic information; significant past and family history; patient-specific reminders; legal directives; and any other information deemed important by the said healthcare practitioner.

5. The method according to claim 1 further comprising:
sharing crucial and significant information with at least a second authorized healthcare practitioner wherein sharing is independent of at least one of the provider's medical management system platforms and data processing capabilities.

6. The method according to claim 1, wherein crucial and significant information display window is activated by the authorized first healthcare practitioner using software interface comprising of a link on a medical patient record window.

7. The method according to claim 6, wherein the link is coded wherein the coding represents the presence or absence of crucial and significant information pertaining to the patient.

8. The method according to claim 5, wherein the patient's identifier is at least one of patient's name, social security number, or a system assigned unique number.

9. A computer executable program product for assisting a first authorized healthcare practitioner to access crucial and significant information of a patient along with medical data, the product comprising:
at least one machine readable medium; computer code stored on the at least one machine readable medium comprising instructions for: recording crucial and significant information as defined by the healthcare practitioner in a customizable form; storing crucial and significant information in a computer data storage; accessing medical data; and displaying stored crucial and significant information on a display screen wherein the screen is activated instantly as the patient's identifier is entered by an authorized user for accessing medical data.

10. The product according to claim 9 further comprising:
computer code with instructions for editing crucial and significant information and saving the edits.

11. The product according to claim 10 further comprising:
computer code with instructions for sorting means to rearrange crucial and significant information according to a set of healthcare practitioner defined criteria.

12. The product according to claim 9, wherein crucial and significant information display screen is activated by the authorized first healthcare practitioner using a software interface comprising of a coded link wherein the coding represents the presence or absence of crucial and significant information pertaining to the patient.

13. The product according to claim 9 further comprising:
computer code with instructions to share crucial and significant information with at least one of at least a second authorized healthcare provider and at least a healthcare agency wherein sharing is independent of at least one of the provider's medical management system platforms and data processing capabilities.

14. The product according to claim 9, crucial and significant information comprises at least one of: adverse drug reactions; adverse food reactions; major health conditions; chronic health conditions; major surgery; major non-surgical medical procedures; genetic information; significant past and family history; patient-specific reminders; legal directives; and any other information deemed important by the said healthcare practitioner.

15. The product according to claim 9, wherein computer code with instructions for displaying of stored crucial and significant information includes privacy protected by a personal identification number created by the authorized user.

16. The product according to claim 9, wherein the patient's identifier is at least one of patient's name, social security number, or a system assigned unique number.

17. A system to assist an authorized first healthcare practitioner to access crucial and significant information of a patient along with medical data, the system comprising:
a recording means to capture crucial and significant information as defined by the healthcare practitioner in a customizable form;
a storage means to store crucial and significant information on a computer;
an interface to access medical data; and
a display means to display crucial and significant information on a display screen wherein the screen is activated instantly as the patient's identifier comprising at least one of: patient's name, social security number, or a system assigned unique number is entered by an authorized user for accessing medical data.

18. The system according to claim 17 further comprising:
an editing means to modify or update crucial and significant information and a means for saving the edits.

19. The system according to claim 17 further comprising:
a sorting means to rearrange crucial and significant information according to a set of healthcare practitioner defined criteria.

20. The system according to claim 17 further comprising:
a means to share crucial and significant information with at least one of at least a second authorized healthcare provider and at least a healthcare agency.
